(19) United States
(12) Patent Application Publication
(10) Pub. No.: US 2007/0295449 A1
(43) Pub. Date: Dec. 27, 2007

(54) Devices and methods for applying pressure-sensitive adhesive liner-less labels to articles

(75) Inventors: Jack L. Clinkenbeard SR., Yorba Linda, CA (US); Israel Vega, Brea, CA (US)

Correspondence Address: STOUT, UXA, BUYAN & MULLINS LLP, 4 VENTURE, SUITE 300, IRVINE, CA, 92618, US

(73) Assignee: Impaxx Machine Systems, Inc., Fullerton, CA (US)

(21) Appl. No.: 11/809,793

(22) Filed: Jun. 1, 2007

Related U.S. Application Data
(60) Provisional application No. 60/810,771, filed on Jun. 2, 2006.

(51) Int. Cl. B29C 65/00

(52) U.S. Cl. 156/285; 156/358

(57) ABSTRACT

A label application system for liner-less pressure sensitive adhesive-backed labels comprises a label sensor disposed at a junction between a drive roller and a vacuum belt. When the leading edge of a passing label is detected, the drive roller is stopped, while the vacuum drive belt continues to advance, thus pulling the label in question distally, relative to its trailing connected label, which is stopped on the drive roller. This applied force functions to separate the label from its trailing label, along a micro-perforation between the two labels, following which the separated leading label travels along the vacuum belt and is applied to an article passing on an adjacent conveyor system.

This application claims the benefit under 35 U.S.C. 119(e) of the filing date of Provisional U.S. Application Ser. No. 60/810,771, entitled Devices & Methods for Applying Pressure-Sensitive Adhesive Liner-Less Labels to Articles, filed on Jun. 2, 2006. This prior provisional application is expressly incorporated herein by reference.

### FIELD OF THE INVENTION

This invention relates generally to label applicators and more particularly, to label applicators and methods for applying pressure-sensitive adhesive liner-less labels to passing articles.

### BACKGROUND OF THE INVENTION

Label applicators for applying pressure-sensitive adhesive-backed labels to articles passing the applicator on a conveyor are well known. Label applicators of this general type are shown in commonly assigned U.S. Pat. No. 4,255,220, issued to Kucheck et al., and U.S. Pat. No. 4,844,771, issued to Crankshaw et al, for example. Other prior art references of interest include Published U.S. Patent Application No. 2003/0121593, U.S. Pat. No. 5,935,361 to Takahashi et al., U.S. Pat. No. 5,643,395 to Hinton, U.S. Pat. No. 5,039,374 to Winter, and Published U.S. Patent Application No. US 2003/0121593. All of the aforementioned patents and published patent applications are herein expressly incorporated by reference. Typically, such labeling apparatus comprise a supply of adhesive-backed labels carried upon an elongate web of release material which is fed from a supply reel to a take-up reel, with the label applicator disposed between the two reels.

In some applications, it is presently desired to utilize pressure-sensitive adhesive-backed labels which are not carried on such a web, in order to eliminate the need to dispose of the waste web collected on the take-up reel, once the labels thereon have been dispensed. In particular, it is becoming increasingly common for governments to impose punitive fees for disposing of waste generated during manufacturing processes, and there is also a cost savings if materials such as the carrier web can be eliminated. Accordingly, companies such as Catchpoint, Inc., having a U.S. office in Piscataway, N.J., have developed liner-less labels, which are described at its website, www.catchpointlabels.com. Such labels are also described, for example, in U.K. Patent Application No. 0501369.3, filed on Jan. 22, 2005 and entitled Improvements to Labels and Application Apparatus therefor, herein expressly incorporated by reference.

These new label types are not amenable to application using existing label applicator systems and processes. Accordingly, what is needed are new or modified systems and processes for efficiently and reliably separating and dispensing these types of labels.

### SUMMARY

The present invention addresses the above identified problem by employing a coordinated drive roller and vacuum belt system for applying a distally directed tensile force (i.e. a tensile force applied in the same direction as the direction of travel of the label feedpath) at an appropriate time for separating the connected labels from one another reliably and without tearing the labels. This force is applied by determining when a label's leading edge passes the nip point of the drive roller and before the label sensor, which is disposed at a junction between the drive roller and the vacuum belt. At this moment, the drive roller is stopped, while the vacuum drive belt continues to advance, thus pulling the label in question distally, relative to its trailing label, which is stopped on the drive roller. This precision operation has been found to be simple and effective, and to reliably and accurately dispense labels of the type described for application on articles passing on an adjacent conveyor system.

More particularly, there is provided a label application system for applying pressure sensitive liner-less labels to passing articles, which comprises an unwind assembly adapted for carrying a roll of pressure sensitive liner-less labels and unwinding the labels into a label feedpath. The labels are connnected to one another end-to-end. The system further comprises a drive area, comprising a main drive roller and a nip roller assembly. The nip roller assembly comprises a nip roller, wherein the main drive roller and the nip roller are disposed so that the label feedpath feeds sequential connected labels between the main drive roller and the nip roller. A first stepper motor is provided for rotating the main drive roller. A vacuum drive belt is disposed downstream of the main drive roller, wherein the labels are advanced by the main drive roller onto the vacuum drive belt. A second stepper motor is provided for driving the vacuum drive belt. A processor functions to count the steps of the first stepper motor.

In preferred embodiments of the invention, there is a dancer arm on the unwind assembly for absorbing initial acceleration forces on the labels, in order to prevent premature label separation.

Operationally, the processor is adapted to stop the first stepper motor after a predetermined number of motor steps have been counted, so that continued operation of the second stepper motor functions to assist in separating adjacent ones of the labels as the labels are advanced onto the vacuum drive belt. A label sensor, disposed in the drive area, assists the processor in determining when to commence the counting step. The label sensor is adapted to sense when a leading edge of an advancing label reaches a predetermined point on the label feedpath, and to provide feedback to the processor.

Preferably, the nip roller assembly and the vacuum drive belt are oriented at approximately the same angle, so that an angle of orientation between the nip roller assembly and the vacuum drive belt is approximately zero.

In another aspect of the invention, there is provided a label application system for applying pressure sensitive liner-less labels to passing articles, which comprises a dispenser for dispensing a plurality of pressure sensitive liner-less labels into a label feedpath, wherein the labels are connected to one another end-to-end. A main drive roller is disposed along the label feedpath, and a vacuum drive belt is disposed downstream of the main drive roller. Thus, the connected labels are advanced by the main drive roller onto the vacuum drive belt. A first motor is provided for rotating the main drive roller, and a second motor is provided for driving the vacuum drive belt. A processor is provided for differentially driving the first and second motors, such that the second motor continues operating for a period of time after the first motor has been stopped, while one of the labels is advancing onto the vacuum drive belt. As a result of this differential operation, a tensile force is exerted on the label to separate it from its adjacent label.

Preferably, both the first and second motors comprise stepper motors. A counter is provided for counting the steps of the first motor during operation thereof. The processor is adapted to stop the first stepper motor after a predetermined number of motor steps have been counted, so that continued operation of the second motor functions to assist in separating adjacent ones of the labels as the labels are advanced onto the vacuum drive belt.

Additional features of the inventive system may include a dancer arm on the label dispenser for absorbing initial acceleration forces on the labels, in order to prevent premature label separation. A label sensor is provided, which is adapted to sense when a leading edge of an advancing label reaches a predetermined point on the label feedpath, and to provide feedback to the processor.

In still another aspect of the invention, there is disclosed a method of applying pressure sensitive liner-less labels to passing articles, which comprises a step of advancing a chain of adjacent, attached pressure sensitive liner-less labels along a label feedpath to a position adjacent to a main drive roller, driven by a first motor. The labels are further advanced, sequentially, onto a vacuum drive belt, which is driven by a second motor. A further step involves sensing when a leading edge of a label advances to a predetermined point on the label feedpath, in proximity to a junction between the main drive roller and the vacuum drive belt. The first motor is stopped after a predetermined period of time has passed from the time when the label leading edge was sensed. Since the second motor continues to operate, the leading edge of the label continues to advance along the vacuum drive belt, relative to the next label, which is stopped on the main drive roller, thereby exerting a force which separates the leading label from its adjacent label.

Preferably, the first motor comprises a stepper motor, and the stopping step discussed above comprises a step of starting a counter for counting first motor steps, and stopping the first motor after a predetermined number of motor steps have been counted.

The invention, together with additional features and advantages thereof, may be best understood by reference to the following description taken in conjunction with the accompanying illustrative drawings. In these accompanying drawings, like reference numerals designate like parts throughout the figures.

### BRIEF DESCRIPTION OF THE DRAWINGS

FIG. 1 is a schematic view of a labeling system constructed in accordance with the principles of the present invention;

FIG. 2 is a top schematic view of the system shown in FIG. 1;

FIG. 3 is a schematic view, from the right side, of the system shown in FIGS. 1 and 2;

FIG. 4 is an enlarged schematic view of the drive area portion of the system shown in FIGS. 1-3;

FIG. 5 is a schematic view, in isolation, of the main drive roller assembly;

FIG. 6 is a bottom view of the main drive roller assembly shown in FIG. 5;

FIG. 7 is a top schematic view, in isolation, of the vacuum grid assembly;

FIG. 8 is a front view of the vacuum grid assembly shown in FIG. 7;

FIG. 9 is a top schematic view, in isolation, of the nip roller drive assembly;

FIG. 10 is front view of the nip roller drive assembly shown in FIG. 9;

FIG. 11 is side view of the nip roller drive assembly shown in FIGS. 9 and 10; and

FIG. 12 is a schematic view illustrating a series of connected labels 14.

### DETAILED DESCRIPTION OF THE INVENTION

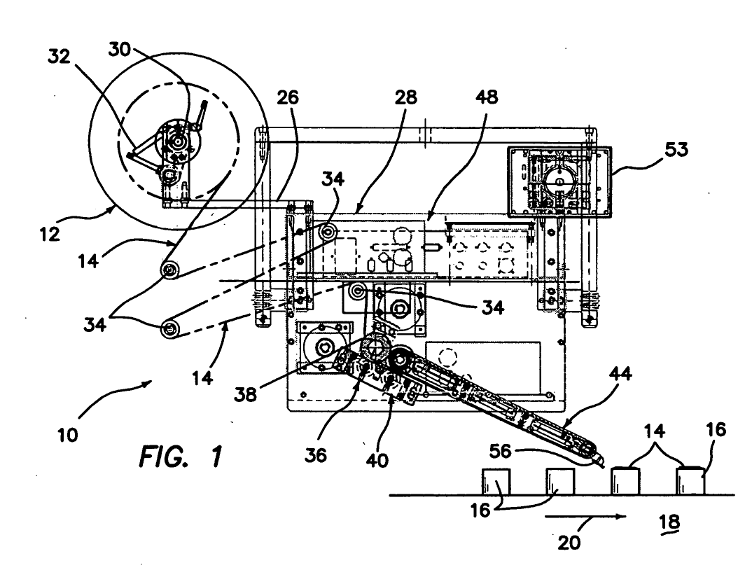

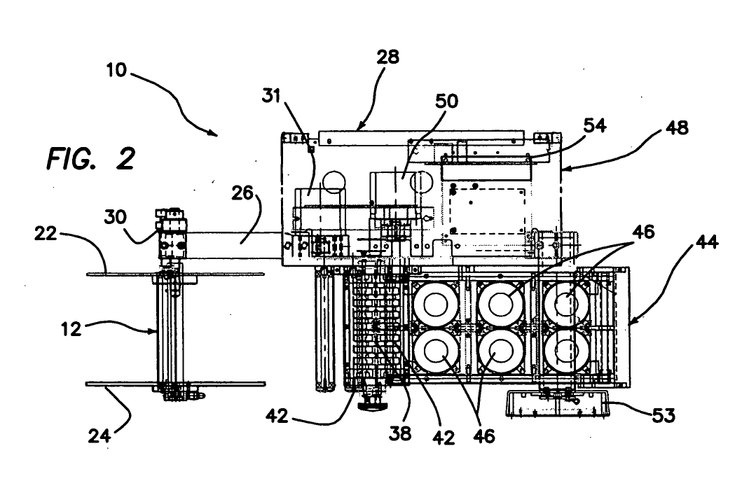

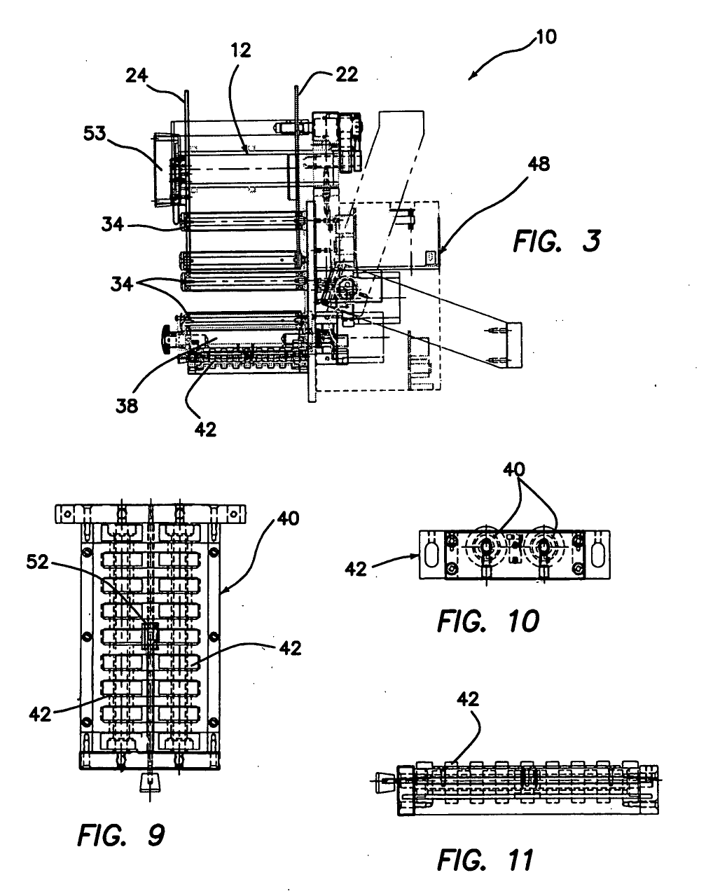

Referring now to the drawings, wherein like reference numerals designate identical or corresponding parts throughout the several views and embodiments, there is shown in FIGS. 1-3 a label applicator 10. The label applicator 10 comprises an unwind assembly 12 on which is carried a roll of labels 14 for application to passing articles 16 on a conveyor 18, which moves in a direction indicated by an arrow 20. The unwind assembly 12 is comprised of an inner assembly unwind disk 22 (FIG. 2) and an outer assembly unwind disk 24. An assembly unwind block 26 supports the unwind assembly 12 on a housing 28. The unwind assembly 12 is rotatably driven through an assembly unwind drive mechanism 30, also supported on the assembly unwind block 26, and an associated motor 31. A dancer arm 32 is provided on the unwind assembly for absorbing initial acceleration of label movement, for purposes to be described more fully hereinbelow.

The labels 14 are preferably pressure sensitive adhesive labels which are of a recently available type manufactured and distributed, for example, by Catchpoint, Inc., as discussed above. Conventional pressure sensitive adhesive labels are labels which have been die cut on a release web or liner, which has a combination of face material and pressure sensitive adhesive applied to it. These labels are manufactured in rolls. As each label is dispensed, for application to an article, it is peeled off of the release liner and applied to the article. The primary purpose of the release liner is to carry the label to a dispense point, where the label is removed from the release liner. Once all of the labels are removed from the release liner, the liner, which has been again rolled up onto a second spool, is discarded.

In contrast, as shown particularly in FIG. 12, in the present invention, the labels 14 comprise a single web on which the labels 14 are printed at spaced intervals, wherein the labels comprise the entirety of the web, and are connected to one another end-to-end by full width transverse lines of weakness 33, typically a micro-perforation. Each label 14 comprises a leading edge 14a and a trailing edge 14b, as shown. Thus, once the labels 14 have been dispensed, there is no remaining carrier web to dispose of, which is a substantial environmental advantage. As noted previously, such labels are described in detail, for example, in U.K. Patent Application No. 0501369.3. More information on some of the types of labels which may be suitable for use in the inventive system is available at www.catchpointlabels.com.

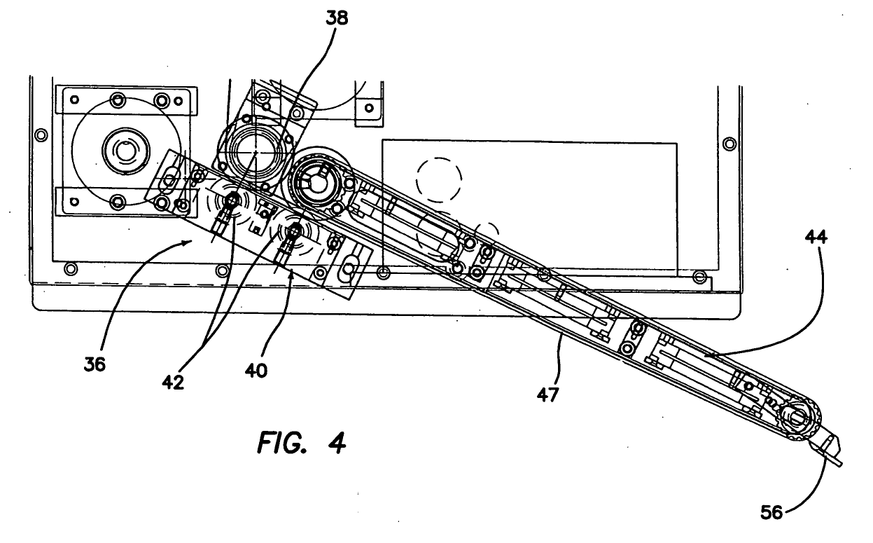

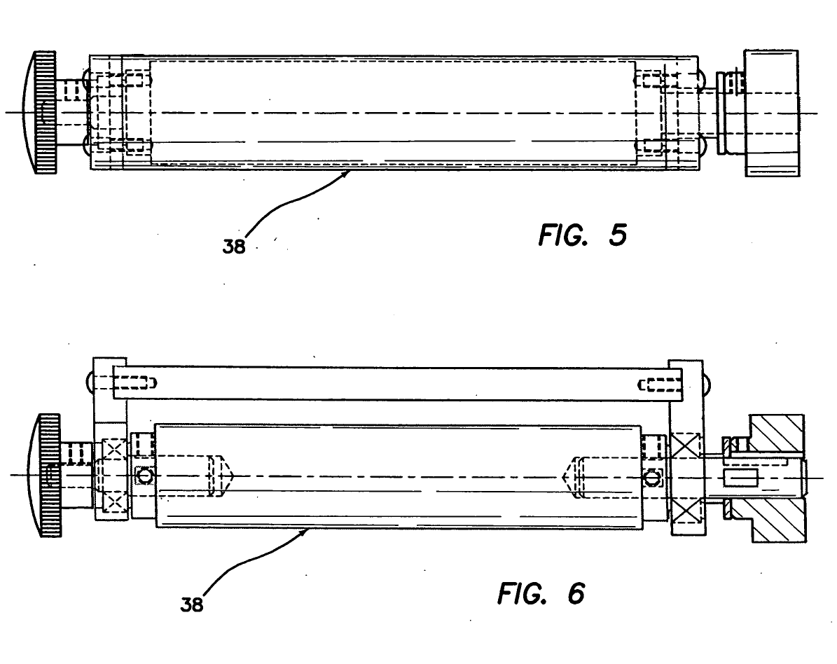

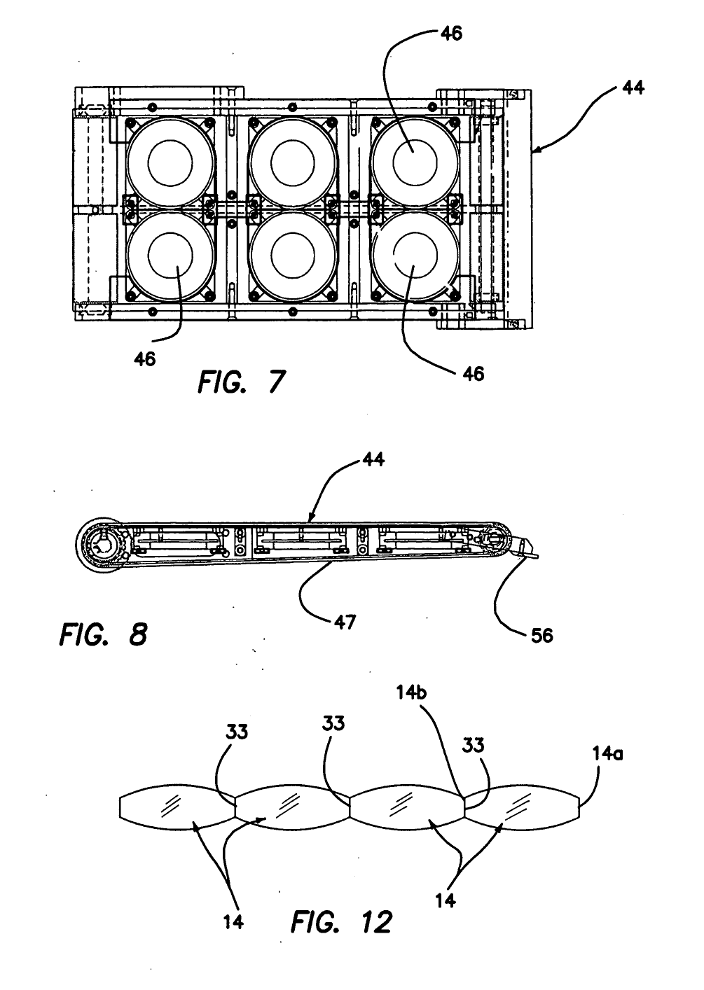

Labels 14 unwinding from the unwind assembly 12 are routed about idler rollers 34 (FIG. 1) along a feedpath to a drive area 36, which is more particularly shown in FIG. 4. The drive area 36 comprises a main drive roller 38 (illustrated in enlarged view in FIGS. 5 and 6), a nip roller drive 40, comprising a plurality of nip rollers 42, and an assembly vacuum grid assembly 44, which is more particularly shown in FIGS. 7 and 8. The label feedpath is directed between the main driver roller 38 and the nip rollers 42, then onto the vacuum grid assembly 44. The vacuum grid assembly comprises a plurality of vacuum fans 46 (FIG. 2) disposed beneath a vacuum drive belt 47 for receiving and retaining labels 14 thereon, as will be described below.

Within a control box or enclosure 48 are disposed the electrical controls necessary to operate the system. Included therein is a drive roller stepper motor 50, together with various components, such as brackets, pulleys, and gearbelts, for connecting the stepper motor 50 to the drive roller 38.

The nip roller drive 40 is more particularly shown in FIGS. 9-11. In addition to the rollers 42, there is disposed within the drive 40 a sensor block 52, as shown.

In operation, an operator activates the label application system by actuation of an appropriate control switch on an operator control box 53. Once operational, the labels 14 are unwound from a roll of labels disposed on the unwind assembly 12. The dancer arm 32 functions to absorb initial acceleration of label movement, in order to keep the labels 14 from separating from one another prematurely. The labels pass along the illustrated label feedpath (FIG. 1), about idlers 34, until they arrive at the main drive area 36. The main drive roller 38 is preferably silicone coated, and is powered by the stepper motor 50. The feedpath carries the still-connected labels 14 between the drive roller 38 and a first nip roller 42 of the nip roller drive 40. The nip roller drive 40 comprises a plurality of nip rollers 42 (two are shown), which are preferably plasma coated with a high release material.

The main drive assembly 36, comprising the main drive roller 38 in combination with the nip roller drive 40, functions to advance the labels 14 to the assembly vacuum grid 44. In particular, the labels are advanced to the vacuum drive belt 47, which is also powered by a stepper motor 54. The labels are fed between the vacuum drive belt and a second nip roller 42, and are retained on the vacuum drive belt 47 because of perforations in the belt, and continued operation of the underlying vacuum fans 46.

Between the main driver roller assembly 36 and the vacuum drive assembly 44, is the above described label sensor 52. In the illustrated embodiment, the label sensor 52 is disposed on the nip roller assembly (FIG. 9), between the two nip rollers 42, so that it is located approximately at the junction between the main drive roller assembly 36 and the vacuum drive belt 47. The label sensor 52 functions to sense the beginning and end of each label 14.

The labels 14 are separated from one another during the transit between the main drive area 36 and the vacuum drive belt 47. The separation process occurs as follows. First, both motors 50 and 54, driving the drive roller 38 and vacuum drive belt 47, respectively, are turned on at the same time. As each label leading edge passes the label sensor 52, a processor in the control box 48 or operator control box 53 starts a counter for counting motor steps. When the proper number of motor steps occur, the processor stops the main drive motor 50, but continues operating the vacuum belt drive motor 54. The processor then monitors the label sensor, looking for the trailing edge of the label. Once the label trailing edge is sensed, the processor continues to run the motor 54 until the now separated label 14 reaches the end of the vacuum belt. The label is then dispensed onto a passing article 16, in a conventional manner, over a distal peeling edge 56 on the belt 47.

As illustrated in the drawings, it is preferably the case that the nip roller assembly is oriented at an angle similar to or equal to that at which the vacuum drive belt 47 is oriented. In other words, the preferred angle of orientation between the nip roller assembly and the vacuum drive belt is approximately zero.

As is apparent from the above description, to those skilled in the art, the continued operation of the stepper motor 54, after the stepper motor 50 ceases function, causes a distally directed tensile force to be applied to the label, because the vacuum drive belt 47 is continuing to move, while the main drive roller 38 is stopped. This applied tensile force is sufficient to tear the label 14 away from the label 14 connected thereto at its trailing edge 14b, at the aforementioned line of weakness 33. The applied tensile force is sufficient to tear the microperforation 33, but not enough to tear the label 14 itself.

While this invention has been described with respect to various specific examples and embodiments, it is to be understood that various modifications may be made without departing from the scope thereof. Therefore, the above description should not be construed as limiting the invention, but merely as an exemplification of preferred embodiments thereof and that the invention can be variously practiced within the scope of the following claims.

What is claimed is:

1. A label application system for applying pressure sensitive liner-less labels to passing articles, comprising:
an unwind assembly adapted for carrying a roll of pressure sensitive liner-less labels and unwinding said labels into a label feedpath, said labels being connected to one another end-to-end;
a drive area, comprising a main drive roller and a nip roller assembly, said nip roller assembly comprising a nip roller, wherein the main drive roller and the nip roller are disposed so that said label feedpath feeds sequential connected labels between said main drive roller and said nip roller;
a first stepper motor for rotating said main drive roller;
a vacuum drive belt disposed downstream of said main drive roller, wherein said labels are advanced by said main drive roller onto said vacuum drive belt;
a second stepper motor for driving said vacuum drive belt; and
a processor for counting the steps of said first stepper motor.

2. The label application system as recited in claim 1, and further comprising a dancer arm on said unwind assembly for absorbing initial acceleration forces on said labels, in order to prevent premature label separation.

3. The label application system as recited in claim 1, wherein said processor is adapted to stop said first stepper motor after a predetermined number of motor steps have been counted, so that continued operation of said second stepper motor functions to assist in separating adjacent ones of said labels as the labels are advanced onto said vacuum drive belt.

4. The label application system as recited in claim 3, and further comprising a label sensor.

5. The label application system as recited in claim 4, wherein said label sensor is adapted to sense when a leading edge of an advancing label reaches a predetermined point on said label feedpath, and to provide feedback to said processor.

6. The label application system as recited in claim 1, wherein said nip roller assembly and said vacuum drive belt are oriented at approximately the same angle, so that an angle of orientation between the nip roller assembly and the vacuum drive belt is approximately zero.

7. A label application system for applying pressure sensitive liner-less labels to passing articles, comprising:
a dispenser for dispensing a plurality of pressure sensitive liner-less labels into a label feedpath, said labels being connected to one another end-to-end;
a main drive roller disposed along said label feedpath;
a vacuum drive belt disposed downstream of said main drive roller, wherein said connected labels are advanced by said main drive roller onto said vacuum drive belt;
a first motor for rotating said main drive roller;
a second motor for driving said vacuum drive belt; and
a processor for differentially driving said first and second motors, such that said second motor continues operating for a period of time after said first motor has been stopped, while one of said labels is advancing onto said vacuum drive belt, thereby exerting a tensile force on said label to separate it from its adjacent label.

8. The label application system as recited in claim 7, wherein said first motor comprises a stepper motor.

9. The label application system as recited in claim 7, wherein said second motor comprises a stepper motor.

10. The label application system as recited in claim 8, and further comprising a counter for counting the steps of said first motor during operation thereof.

11. The label application system as recited in claim 10, wherein said processor is adapted to stop said first stepper motor after a predetermined number of motor steps have been counted, so that continued operation of said second motor functions to assist in separating adjacent ones of said labels as the labels are advanced onto said vacuum drive belt.

12. The label application system as recited in claim 7, and further comprising a dancer arm on said label dispenser for absorbing initial acceleration forces on said labels, in order to prevent premature label separation.

13. The label application system as recited in claim 7, and further comprising a label sensor.

14. The label application system as recited in claim 13, wherein said label sensor is adapted to sense when a leading edge of an advancing label reaches a predetermined point on said label feedpath, and to provide feedback to said processor.

15. A method of applying pressure sensitive liner-less labels to passing articles, comprising:
advancing a chain of adjacent, attached pressure sensitive liner-less labels along a label feedpath to a position adjacent to a main drive roller, driven by a first motor;
further advancing said labels, sequentially, onto a vacuum drive belt, which is driven by a second motor;
sensing when a leading edge of a label advances to a predetermined point on said label feedpath, in proximity to a junction between said main drive roller and said vacuum drive belt; and
stopping said first motor after a predetermined period of time has passed from the time when said label leading edge was sensed.

16. The method as recited in claim 15, wherein said second motor continues to operate after said first motor has been stopped.

17. The method as recited in claim 15, wherein said first motor comprises a stepper motor, and said stopping step comprises a step of starting a counter for counting first motor steps, and stopping said first motor after a predetermined number of motor steps have been counted.
